(19) United States
(12) Patent Application Publication
(10) Pub. No.: US 2022/0283653 A1
(43) Pub. Date: Sep. 8, 2022

(54) STACKING STRUCTURE AND TOUCH SENSOR

(71) Applicant: Cambrios Film Solutions Corporation, Tortola (VG)

(72) Inventors: Chung-Chin Hsiao, Hsinchu County (TW); Siou-Cheng Lien, Miaoli County (TW); Yi-Wen Chiu, Taoyuan City (TW); Chia-Yang Tsai, New Taipei City (TW)

(21) Appl. No.: 17/192,058

(22) Filed: Mar. 4, 2021

(51) Int. Cl. G06F 3/041

(52) U.S. Cl. CPC G06F 3/041; G06F 2203/04103

(57) ABSTRACT

A stacking structure includes a substrate, a silver nanowire layer disposed on a top of the substrate, and a metal layer disposed on a top of the silver nanowire layer. The silver nanowire layer includes a plurality of silver nanowires and a protective coating covering the silver nanowires. The silver nanowire layer has a thickness ranging from 40 nm to 120 nm. A touch sensor including the above-described stacking structure is also disclosed.

### BACKGROUND

### 1. Field of the Disclosure

The present disclosure relates to a stacking structure, and more particularly, to a stacking structure including a silver nanowire layer. The present disclosure also relates to a touch sensor that includes the above-mentioned stacking structure.

### 2. Description of the Related Art

A stacking structure including silver nanowires and metal layers can be applied to the manufacturing of a touch sensor. Conventionally, a trace area (TA) including silver traces is formed around a border of the stacking structure through silver paste screen printing and laser processing, and a visible area (VA) without silver traces is formed at a central area of the stacking structure. With these arrangements, the stacking structure can be applied to the manufacturing of the touch sensor.

FIG. 1 is a schematic view showing a trace area 4 for a touch sensor formed on a conventional stacking structure through silver paste screen printing and laser processing. As shown in FIG. 1, the trace area 4 includes a substrate 1, a silver nanowire layer 2 formed on a top of the substrate 1, and a metal layer 3 formed on a top of the silver nanowire layer 2 and including a plurality of metal traces 5. Since there is a limit to the laser spot size in the laser processing, the plurality of metal traces 5 in the trace area 4 has a minimum trace width 6 of 30 μm and a minimum trace pitch 7 of 30 μm, which are too large to be applied to the manufacturing of a small-size touch sensor that requires a narrow border.

### BRIEF SUMMARY OF THE DISCLOSURE

An objective of the present disclosure is to provide an improved stacking structure and a touch sensor including the same, so as to overcome the problem in the conventional stacking structure that the trace area thereof formed through silver paste screen printing and laser processing has a relatively large trace width and a relatively large trace pitch.

To achieve at least the above objective, the stacking structure according to the present disclosure includes:

a substrate;

a silver nanowire layer disposed on a top of the substrate; and

a metal layer disposed on a top of the silver nanowire layer,

wherein the silver nanowire layer includes:
a plurality of silver nanowires; and
a protective coating covering the silver nanowires, and

wherein the silver nanowire layer has a thickness ranging from 40 nm to 120 nm.

In the above stacking structure, the protective coating is formed of a material selected from the group consisting of epoxy acrylate resins, urethane acrylate resins, polyester acrylate resins, and polyether acrylate resins.

The above stacking structure can further include:

a second silver nanowire layer disposed on a bottom of the substrate; and

a second metal layer disposed on a bottom of the second silver nanowire layer,

wherein the second silver nanowire layer includes:
a second plurality of silver nanowires; and
a second protective coating covering the second plurality of silver nanowires, and

wherein the second silver nanowire layer has a thickness ranging from 40 nm to 120 nm.

In the above stacking structure, the metal layer has a thickness ranging from 150 nm to 300 nm.

In the above stacking structure, the substrate has a thickness ranging from 10 μm to 150 μm.

To achieve at least the above objective, the touch sensor according to the present disclosure includes a stacking structure as mentioned above.

In the above touch sensor, the silver nanowire layer and the metal layer of the stacking structure can be patterned.

In the above touch sensor, the silver nanowire layer, the second silver nanowire layer, the metal layer, and the second metal layer of the stacking structure can be patterned.

Since the stacking structure of the present disclosure can be etched and patterned through the photolithography process, the trace area formed thereon can have relatively narrower trace width and relatively smaller trace pitch, which allows the touch sensor using the stacking structure of the present disclosure to realize the narrow-border design.

### BRIEF DESCRIPTION OF THE DRAWINGS

FIG. 1 is a schematic view showing a trace area formed on a conventional stacking structure through silver paste screen printing and laser processing.

FIG. 2 is a schematic view of a stacking structure according to a first embodiment of the present disclosure.

FIG. 3 is a schematic view of a stacking structure according to a second embodiment of the present disclosure.

FIG. 4 is a flowchart showing steps for preparation of a touch sensor according to a third embodiment of the present disclosure.

FIG. 5 is a picture of a half-finished product of the touch sensor according to the third embodiment of the present disclosure after a photoresist is removed therefrom.

FIG. 6 is a picture of a finished product of the touch sensor according to the third embodiment of the present disclosure after a second photoresist is removed therefrom.

FIG. 7 is a schematic view showing a trace area on the touch sensor according to the third embodiment of the present disclosure.

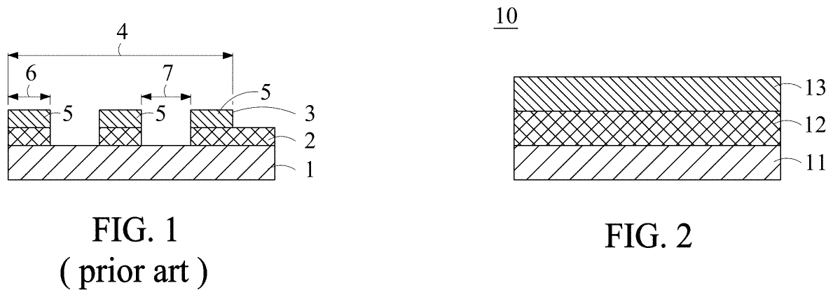

### DETAILED DESCRIPTION

To facilitate understanding of the objects, characteristics, and effects of this present disclosure, embodiments together with the attached drawings for the detailed description of the present disclosure are provided. A person of ordinary skill in the art can understand the advantages and benefits of the present disclosure from the contents of the specification. It is noted that the present disclosure can be implemented or applied in other embodiments, and many changes and modifications in the described embodiments can be carried out without departing from the spirit of the disclosure, and it is also understood that the preferred embodiments are only illustrative and not intended to limit the present disclosure in any way.

In the specification and the appended claims, the use of the singular form of a word indicated by “a” or “the” shall construed to include the plural unless the context indicates otherwise.

In the specification and the appended claims, the use of the term “or” includes the meaning of “and/or” unless the context indicates otherwise.

In the specification and the appended claims, the term “trace width” indicates a width of one metal trace.

In the specification and the appended claims, the term “trace pitch” indicates the shortest distance between an edge of one metal trace and a facing edge of another parallelly adjacent metal trace.

### First Embodiment

FIG. 2 is a schematic view of a stacking structure 10 according to a first embodiment of the present disclosure. As shown in FIG. 2, the stacking structure 10 in the first embodiment includes a substrate 11, a silver nanowire layer 12 formed on a top of the substrate 11, and a metal layer 13 formed on a top of the silver nanowire layer 12. The silver nanowire layer 12 includes a plurality of silver nanowires and a protective coating covering the plurality of silver nanowires. The silver nanowire layer 12 has a thickness ranging from 40 nm to 120 nm.

In the stacking structure 10 according to the first embodiment, materials suitable for making the substrate 11 include, but are not limited to, polyethylene terephthalate (PET), cyclic olefin copolymer (COP), and colorless polyimide (CPI), all of which are transparent plastic materials. In addition, the substrate 11 has a thickness ranging from 10 μm to 150 μm.

In the stacking structure 10 according to the first embodiment, the protective coating may be formed of a material selected from the group consisting of, but not limited to, epoxy acrylate resins, urethane acrylate resins, polyester acrylate resins, and polyether acrylate resins.

In the stacking structure 10 according to the first embodiment, the silver nanowire layer 12 has a thickness ranging from 40 nm to 120 nm. When the silver nanowire layer 12 has a thickness smaller than 40 nm, the protective coating in the silver nanowire layer 12 is too thin to provide sufficient protection to the silver nanowires against damage by an etchant used in a photolithography process, which is often employed in fabricating stacking structures. Damaged silver nanowires will have degraded conductivity, preventing the stacking structure including them from being advantageously applied to the manufacturing of a touch sensor. Meanwhile, when forming the metal layer 13 on the top of the silver nanowire layer 12 through a metal deposition process, the excessively thin protective coating is not sufficient for protecting the silver nanowires against damage in the metal deposition process. Again, the damaged silver nanowires prevent the stacking structure including them from being advantageously applied to the manufacturing of a touch sensor. On the other hand, when the silver nanowire layer 12 has a thickness larger than 120 nm, the protective coating in the silver nanowire layer 12 is too thick, which results in an excessively high contact impedance between the silver nanowire layer 12 and the metal layer 13, which adversely influences the conductivity of the silver nanowire layer 12 as well as the application of the stacking structure 10 to the touch sensor.

With the above technical feature of having a silver nanowire layer thickness ranging from 40 nm to 120 nm, the metal layer 13 and the silver nanowire layer 12 of the stacking structure 10 can be patterned through the photolithography process to form a trace area having metal traces with smaller trace width and trace pitch. Therefore, the narrow-border design can be realized on the touch sensor that includes the stacking structure 10, and ideal contact impedance can be maintained between the silver nanowire layer 12 and the metal layer 13.

In the stacking structure 10 according to the first embodiment, materials suitable for forming the metal layer 13 include, but are not limited to, copper, nickel, silver, and other alloy metal materials thereof. Further, the metal layer 13 has a thickness ranging from 150 nm to 300 nm. When the metal layer 13 has a thickness smaller than 150 nm, the metal layer 13 is too thin to possess appropriate conductivity, which prevents the stacking structure 10 from being advantageously applied to the manufacturing of the touch sensor. On the other hand, when the metal layer 13 has a thickness larger than 300 nm, the excessively thick metal layer 13 results in poor flexibility of the stacking structure 10.

When forming the stacking structure 10 according to the first embodiment of the present disclosure through the photolithography process, appropriate etchant with high etch selectivity or etchant for one-step etching can be correspondingly used to complete the manufacturing of the touch sensor.

### Second Embodiment

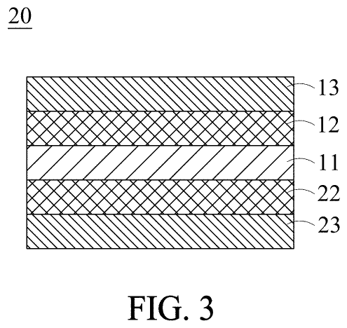

FIG. 3 is a schematic view of a stacking structure 20 according to a second embodiment of the present disclosure. As shown in FIG. 3, like the stacking structure 10 of the first embodiment, the stacking structure 20 in the second embodiment includes a substrate 11, a silver nanowire layer 12 formed on a top of the substrate 11, and a metal layer 13 formed on a top of the silver nanowire layer 12. The silver nanowire layer 12 includes a plurality of silver nanowires and a protective coating covering the plurality of silver nanowires. The silver nanowire layer 12 has a thickness ranging from 40 nm to 120 nm.

Compared to the first embodiment, the stacking structure 20 in the second embodiment further includes a second silver nanowire layer 22 formed on a bottom of the substrate 11 and a second metal layer 23 formed on a bottom of the second silver nanowire layer 22. The second silver nanowire layer 22 includes a plurality of silver nanowires and a second protective coating covering the plurality of silver nanowires in the second silver nanowire layer 22. The second silver nanowire layer 22 has a thickness ranging from 40 nm to 120 nm.

In the stacking structure 20 according to the second embodiment, since the material for forming the second protective coating of the second silver nanowire layer 22, the thickness of the second silver nanowire layer 22, and the material and thickness of the second metal layer 23 are the same as those of the silver nanowire layer 12 and the metal layer 13 in the first embodiment, they are not repeatedly described herein.

The stacking structure 20 of the second embodiment can be applied to the manufacturing of a touch sensor. The metal layer 13 and the silver nanowire layer 12 can be patterned through the photolithography process to form a driving electrode Tx, and the second metal layer 23 and the second silver nanowire layer 22 can be patterned through the photolithography process to form a sensing electrode Rx. The provision of the metal layer 13 and the second metal layer 23 can prevent the stacking structure 20 from being interfered with during a double-side exposure in the photolithography process.

### Third Embodiment

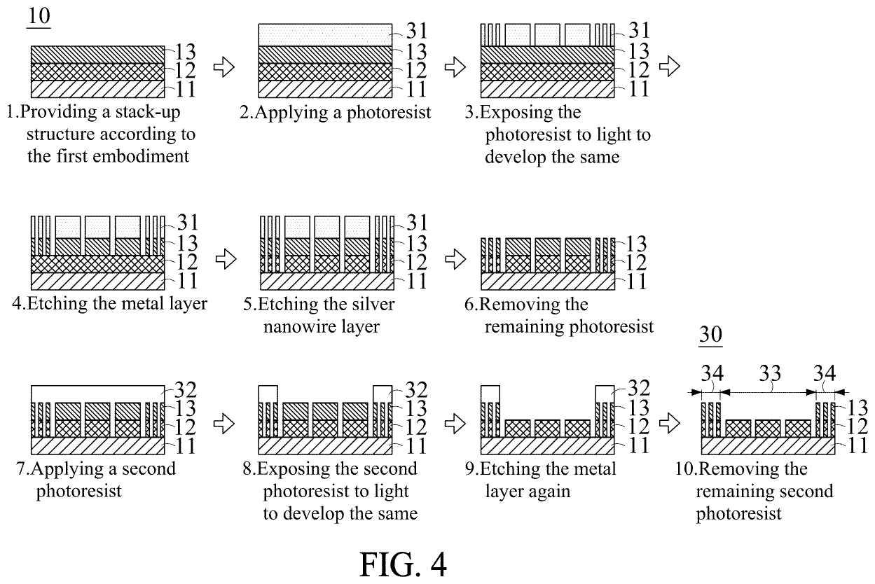

FIG. 4 is a flowchart showing the steps for the preparation of a touch sensor 30 according to a third embodiment of the present disclosure. As shown in FIG. 4, the touch sensor 30 according to the third embodiment includes a stacking structure 10 of the first embodiment, and the stacking structure 10 is patterned to meet the requirement of the touch sensor 30.

As shown in FIG. 4, the following steps are included in the flowchart for the preparation of the touch sensor 30 of the third embodiment:

1. Preparing a stacking structure 10 according to the first embodiment;

2. Applying a photoresist 31 on a top of the metal layer 13;

3. Exposing the photoresist 31 to light to develop and pattern the photoresist 31;

4. Etching the metal layer 13 using an etchant with high etch selectivity;

5. Etching the silver nanowire layer 12 using an etchant with high etch selectivity;

6. Removing the remaining photoresist 31;

7. Applying a second photoresist 32 on the top of the metal layer 13;

8. Exposing the second photoresist 32 to light to develop and pattern the second photoresist 32;

9. Etching the metal layer 13 again using a metal etchant with high etch selectivity; and

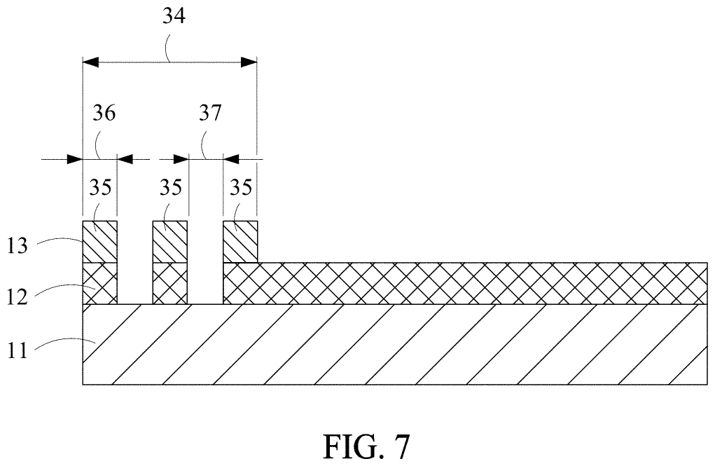

10. Removing the remaining second photoresist 32 to complete a touch sensor 30 according to the third embodiment of the present disclosure. The touch sensor 30 includes a visible area 33, which includes the silver nanowire layer 12 that is not covered by the metal layer 13, and a trace area 34, which includes a plurality of metal traces 35 (see FIG. 7) formed by the metal layer 13.

In some embodiments, the etchant or metal etchant used in at least one of step 4, step 5, or step 9 corresponds to an etching solution described in U.S. patent application Ser. No. 17/126,179, filed Dec. 18, 2020, which is incorporated herein by reference.

In another operable embodiment, a one-step etchant can be used to etch the metal layer 13 and the silver nanowire layer 12 at a same time, so as to complete the steps 4 and 5 in the above touch sensor preparation flow at the same time.

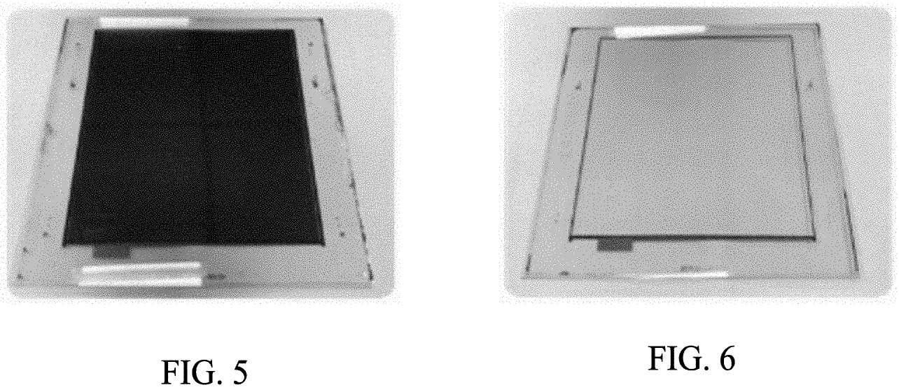

FIG. 5 is a picture of a half-finished product of the touch sensor 30 according to the third embodiment of the present disclosure after the remaining photoresist 31 is removed in the step 6 of the above touch sensor preparation flow. FIG. 6 is a picture of a finished product of the touch sensor 30 according to the third embodiment of the present disclosure after the remaining second photoresist 32 is removed in the step 10 of the above touch sensor preparation flow. As can be seen in FIG. 6, the trace area 34 occupies only a very small part of the border of the touch sensor 30 to realize the narrow-border design.

FIG. 7 is a schematic view showing the trace area 34 on the touch sensor 30 according to the third embodiment of the present disclosure. As shown in FIG. 7, the trace area 34 includes the substrate 11, the silver nanowire layer 12 formed on the top of the substrate 11, and the metal layer 13 formed on the top of the silver nanowire layer 12. Further, the metal layer 13 is patterned to form the plurality of metal traces 35. Through the photolithography process, the metal traces 35 in the trace area 34 have a trace width 36 as narrow as 10 μm and a trace pitch 37 as small as 10 μm, which can be applied to form a small-size touch sensor with narrow border.

In conclusion, the stacking structure and the touch sensor according to the present disclosure provide at least the following advantageous technical effects:

1. The silver nanowire layer in the stacking structure of the present disclosure has a thickness within a specific range, which allows the use of the photolithography process to form the trace area having metal traces with relatively narrower trace width and relatively smaller trace pitch on the stacking structure, which in turn allows the touch sensor including the stacking structure to realize the narrow-border design and overcome the problem of relatively large trace widths and trace pitches in the conventional touch sensor.

2. The silver nanowire layer in the stacking structure of the present disclosure has a thickness within a specific range, which effectively prevents the silver nanowires against damage when the metal layer is formed on the top of the silver nanowire layer through the metal deposition process.

3. The silver nanowire layer in the stacking structure of the present disclosure has a thickness within a specific range, which effectively prevents the silver nanowires against damage when the metal layer is etched during the photolithography process.

4. The provision of the metal layer and the second metal layer in the stacking structure of the present disclosure can prevent the stacking structure from being interfered with during the double-side exposure in the photolithography process.

While the present disclosure has been described by means of specific embodiments, numerous modifications and variations can be made thereto by those skilled in the art without departing from the scope and spirit of the present disclosure set forth in the claims.

1. A stacking structure, comprising:
a substrate;
a silver nanowire layer disposed on a top of the substrate; and
a metal layer disposed on a top of the silver nanowire layer,
wherein the metal layer has a thickness ranging from 150 nm to 300 nm,
wherein the silver nanowire layer comprises:
a plurality of silver nanowires; and
a protective coating covering the plurality of silver nanowires,
wherein the silver nanowire layer has a thickness ranging from 40 nm to 99 nm, and
wherein a sidewall of the metal layer is co-planar with a sidewall of the silver nanowire layer in a trace area of the stacking structure.

2. The stacking structure according to claim 1, wherein the protective coating is formed of a material selected from the group consisting of epoxy acrylate resins, urethane acrylate resins, polyester acrylate resins, and polyether acrylate resins.

3. The stacking structure according to claim 1, further comprising:
a second silver nanowire layer disposed on a bottom of the substrate; and
a second metal layer disposed on a bottom of the second silver nanowire layer,
wherein the second silver nanowire layer comprises:
a second plurality of silver nanowires; and
a second protective coating covering the second plurality of silver nanowires, and
wherein the second silver nanowire layer has a thickness ranging from 40 nm to 120 nm.

4. (canceled)

5. The stacking structure according to claim 1, wherein the substrate has a thickness ranging from 10 μm to 150 μm.

6. A touch sensor, comprising:
a stacking structure according to claim 1.

7. The touch sensor according to claim 6, wherein the silver nanowire layer and the metal layer in the stacking structure have been patterned.

8. A touch sensor, comprising:
a stacking structure according to claim 2.

9. The touch sensor according to claim 8, wherein the silver nanowire layer and the metal layer in the stacking structure have been patterned.

10. A touch sensor, comprising:
a stacking structure according to claim 3.

11. The touch sensor according to claim 10, wherein the silver nanowire layer, the second silver nanowire layer, the metal layer, and the second metal layer all have been patterned.

12. (canceled)

13. A touch sensor, comprising:
a stacking structure according to claim 5.

14. The stacking structure according to claim 2, further comprising:
a second silver nanowire layer disposed on a bottom of the substrate; and
a second metal layer disposed on a bottom of the second silver nanowire layer,
wherein the second silver nanowire layer comprises:
a second plurality of silver nanowires; and
a second protective coating covering the second plurality of silver nanowires, and
wherein the second silver nanowire layer has a thickness ranging from 40 nm to 120 nm.

15. A touch sensor, comprising:
a stacking structure according to claim 14.

16. The touch sensor according to claim 15, wherein the silver nanowire layer, the second silver nanowire layer, the metal layer, and the second metal layer all have been patterned.

17. The stacking structure according to claim 1, wherein the metal layer is non-transparent.

18. The stacking structure according to claim 1, wherein the silver nanowire layer is present in a visible area of the stacking structure and in the trace area of the stacking structure.

19. The stacking structure according to claim 18, wherein the metal layer is present merely in the trace area of the stacking structure.

20. The stacking structure according to claim 1, wherein the metal layer comprises at least one of copper, nickel, or silver.

21. The stacking structure according to claim 1 wherein, in the trace area, the silver nanowire layer and the metal layer define a plurality of traces have a trace width equal to a trace pitch.
